(19) United States
(12) Patent Application Publication
(10) Pub. No.: US 2003/0054165 A1
(43) Pub. Date: Mar. 20, 2003

(54) Stretched resin film and method for manufacturing thereof

(75) Inventors: Masaaki Yamanaka, Ibaraki (JP); Kazuyuki Kimura, Ibaraki (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: YUPO CORPORATION, Chiyoda-ku (JP)

(21) Appl. No.: 10/153,646

(22) Filed: May 24, 2002

Related U.S. Application Data
(63) Continuation of application No. PCT/JP00/08273, filed on Nov. 24, 2000.

(30) Foreign Application Priority Data
Nov. 24, 1999 (JP) 11/332361

(51) Int. Cl. B32B 15/04

(52) U.S. Cl. 428/343; 524/425; 524/445; 524/431; 524/432; 524/433; 524/419

(57) ABSTRACT

A stretched resin film comprises a uniaxially stretched film comprising a propylene-base polymer (A) in an amount of 30 to 79 wt %, polybutene-1 (B) in an amount of 3 to 25 wt %, a petroleum resin (C) and/or hydrogenated terpene resin (D) in an amount of 3 to 25 wt %, and an organic and/or inorganic fine powder (E) in an amount of 10 to 65 wt %. The stretched resin film is a white, opaque film having excellent heat shrinking properties, printability and stiffness, and does not contribute to environmental pollution when burned.

### BACKGROUND OF THE INVENTION

1. Field of the Invention

The present invention relates to an opaque stretched resin film having excellent heat shrinking properties, printability and stiffness, and a method for manufacturing thereof. The stretched resin film of the present invention is useful as a label material or wrapping material for various containers such as dry cells, beverage cans and beverage bottles.

2. Discussion of the Background

Printed vinyl chloride heat-shrinking film is widely used for decorating or wrapping dry cells, beverage cans and beverage bottles. However, an undesirable property of vinyl chloride resin is that it may generate hazardous gases such as hydrogen chloride gas during incineration, which causes environmental pollution. Accordingly, there is increasing research and development of materials using polyolefinic resins in order to avoid such environmental pollution. However, polyolefinic resin based materials have the disadvantage of poor heat-shrinking properties due to the crystallinity of the polyolefinic resin.

In order to overcome this drawback, films based on mixtures of amorphous resins have been evaluated (Japanese Laid-Open Patent Publication Nos. 60-135233, 60-171150 and 07-119317). However, films prepared using amorphous resins cause misalignment of colors during printing due to their poor stiffness, or have poor ink adhesion. In addition, they have poor heat-shrinking properties, which lowers the productivity of the material, and they tend to shrink during storage.

### SUMMARY OF THE INVENTION

It is therefore an object of the present invention to provide a white opaque stretched resin film having excellent heat-shrinking properties, printability and stiffness, and which does not cause environmental pollution. It is another object of the present invention to provide a method for manufacturing the stretched resin film of the present invention. The stretched resin film of the present invention comprises a blend of selected thermoplastic resins which are uniaxially stretched.

### DETAILED DESCRIPTION OF THE INVENTION

The stretched resin film of the present invention therefore comprises a uniaxially stretched film comprising a propylene-based polymer (A) in an amount of 30 to 79 wt %, polybutene-1 (B) in an amount of 3 to 25 wt %, a petroleum resin (C) and/or hydrogenated terpene resin (D) in an amount of 3 to 25 wt %, and an organic and/or inorganic fine powder (E) in an amount of 10 to 65 wt %.

The stretched resin film of the present invention comprises a base layer (i) comprising a uniaxially stretched film, and a surface layer (ii) comprising a uniaxially stretched film formed on at least one surface of the base layer (i); where the base layer (i) comprises a propylene-based polymer (A) in an amount of 45 to 85 wt %, polybutene-1 (B) in an amount of 5 to 30 wt %, a petroleum resin (C) and/or hydrogenated terpene resin (D) in an amount of 5 to 30 wt %, and an organic and/or inorganic fine powder (E) in an amount of 5 to 45 wt %.

The surface layer (ii) comprises a propylene-based polymer (A) in an amount of 30 to 79 wt %, polybutene-1 (B) in an amount of 3 to 25 wt %, a petroleum resin (C) and/or hydrogenated terpene resin (D) in an amount of 3 to 25 wt %, and an organic and/or inorganic fine powder (E) in an amount of 10 to 65 wt %.

The propylene-based polymer (A) of the film of the present invention is preferably a random copolymer (a1) comprising ethylene in an amount of 2 to 10 wt % and propylene in an amount of 90 to 98 wt %; a random copolymer (a2) comprising ethylene in an amount of 0 to 5 wt %, butene-1 in an amount of 8 to 30 wt %, and propylene in an amount of 92 to 65 wt %; a random copolymer (a3) comprising ethylene in an amount of 0 to 5 wt %, propylene in an amount of 65 to 98.5 wt %, and butene-1 in an amount of 0 to 30 wt %; or a propylene homopolymer (a4).

The petroleum resin (C) used in the film of the present invention is preferably a polymer (c1) prepared by the cationic polymerization of a polymerizable composition comprising a C₅ chain olefin; a polymer (c2) prepared by the thermal polymerization of a polymerizable composition comprising dicyclopentadiene; a polymer (c3) prepared by the cationic polymerization of a polymerizable composition comprising a C₉ aromatic olefin; a copolymer (c4) prepared by the cationic polymerization of a polymerizable composition comprising a C₅ chain olefin and a C₉ aromatic olefin; or a polymer (c5) prepared by hydrogenating the foregoing (c1), (c2), (c3) or (c4), or a modified polymer prepared by introducing a carboxylic acid group, maleic anhydride group and/or hydroxyl group to the foregoing (c1), (c2), (c3) or (c4).

The heat-shrinkage ratio in the stretching direction of the stretched resin film of the present invention is preferably 25% or above at 100° C., and 1% or less at 50° C. The Clark stiffness in the stretching direction is preferably within a range from 10 to 300. It is further preferable for the stretched resin film of the present invention to have a total thickness within a range from 30 to 250 μm, where the base layer (i) has a thickness within a range from 50 to 98% of the total thickness of the entire film. The stretched resin film preferably has an opacity of 20% or above, and is preferably has a back surface having a pressure-sensitive adhesion property.

The present invention is also directed to a method for manufacturing a stretched resin film, comprising uniaxially stretching a resin composition which comprises a propylene-based polymer (A) in an amount of 30 to 79 wt %, polybutene-1 (B) in an amount of 3 to 25 wt %, a petroleum resin (C) and/or hydrogenated terpene resin (D) in an amount of 3 to 25 wt %, and an organic and/or inorganic fine powder (E) in an amount of 10 to 65 wt %. A surface layer (ii) is formed on at least one surface of a base layer (i). The resulting laminate of base layer (i) and surface layer (ii) is uniaxially stretched. The base layer (i) comprises a propylene-base polymer (A) in an amount of 45 to 85 wt %, polybutene-1 (B) in an amount of 5 to 30 wt %, a petroleum resin (C) and/or hydrogenated terpene resin (D) in an amount of 5 to 30 wt %, and an organic and/or inorganic fine powder (E) in an amount of 5 to 45 wt %. The surface layer (ii) comprises a propylene-based polymer (A) in an amount of 30 to 79 wt %, polybutene-1 (B) in an amount of 3 to 25 wt %, a petroleum resin (C) and/or hydrogenated terpene resin (D) in an amount of 3 to 25 wt %, and an organic and/or inorganic fine powder (E) in an amount of 10 to 65 wt %.

In the manufacturing method of the present invention, the uniaxial stretching is preferably carried out at a stretching temperature within a range from 65 to 150° C. The film is uniaxially stretched 1.5 to 11 times the original length of the film before stretching. The uniaxially stretched laminate is preferably annealed within a temperature range between the stretching temperature and a temperature which is approximately 30° C. higher than the stretching temperature. The uniaxial stretching of the laminate is preferably carried out by means of the peripheral speeds of roll groups, in which the film is passed over rolls moving at different speeds, or by pinching the laminate with a clip in a heat oven, and then uniaxially extending the film by pulling on the clip.

Embodiments of the stretched resin film of the present invention and the method for manufacturing thereof will be described in further detail hereinafter.

The stretched resin film of the present invention is such that comprises a uniaxially stretched film containing a propylene-based polymer (A) in an amount of 30 to 79 wt %, polybutene-1(B) in an amount of 3 to 25 wt %, a petroleum resin (C) and/or hydrogenated terpene resin (D) in an amount of 3 to 25 wt %, and an organic and/or inorganic fine powder (E) in an amount of 10 to 65 wt %.

The uniaxially stretched film can be used as a surface layer (ii), laminated to various base layers. While the composition of the base layer may be selected depending on the target application, the stretched resin film of the present invention is preferably the surface layer laminated on the base layer (i) which comprises a uniaxially stretched film which contains a propylene-based polymer (A) in an amount of 45 to 85 wt %, polybutene-1 (B) in an amount of 5 to 30 wt %, a petroleum resin (C) and/or hydrogenated terpene resin (D) in an amount of 5 to 30 wt %, and an organic and/or inorganic fine powder (E) in an amount of 5 to 45 wt %. The composition of the stretched resin film of the present invention having a base layer (i) and a surface layer (ii) is not specifically limited, except that it should have a structural unit in which the surface layer (ii) is stacked on the base layer (i). For example, the structural unit may comprise a surface layer (ii) laminated on either surface of the base layer (i), or a surface layer (ii) laminated to both sides of the base layer (i).

The base layer (i) and the surface layer (ii) each comprises propylene-based polymer (A), polybutene-1 (B), a petroleum resin (C) and/or hydrogenated terpene resin (D), and an organic and/or inorganic fine powder (E).

The propylene-based polymer (A) used for the base layer (i) and surface layer (ii) is not specifically limited provided that it contains propylene monomer. For example, the polymer (A) may be a propylene homopolymer in which propylene only is polymerized, or polymer (A) may be a propylene copolymer in which propylene and other polymerizable monomers are co-polymerized. A preferred propylene-based polymer (A) comprises propylene monomer in an amount of 50 wt % or above, more preferably 60 wt % or above, and still more preferably 65 wt % or above. Specific examples of polymer (A) include a random copolymer (a1) comprising 2 to 10 wt % of ethylene and 90 to 98 wt % of propylene; a random copolymer (a2) containing 0 to 5 wt % of ethylene, 8 to 30 wt % of butene-1, and 92 to 65 wt % of propylene; a random copolymer (a3) containing 0 to 5 wt % of ethylene, 98.5 to 65 wt % of propylene and 0 to 30 wt % of butene-1; and propylene homopolymer (a4). Propylene homopolymer (a4) is especially preferred. The propylene-based polymer (A) preferably has a melt flow rate (measured at 230° C., 2.16 kg load) of 0.5 to 30 g/10 min. It should now be noted that, in this specification, any notation for expressing a numerical range using the word “to” indicates a range inclusive of the values placed before and after the word “to.”

The polybutene-1 (B) used for the base layer (i) and surface layer (ii) are not specifically limited. For example, polybutene-1 (B) may be a crystalline homo-polybutene-1, or may be a copolymer comprising a small amount (e.g., 20 wt % or less) of a co-monomer, as long as the polymer retains its crystallinity. Examples of suitable co-monomer include ethylene, propylene and pentene-1. Polybutene-1 (B) preferably has a melt flow rate of 1 g/10 min or above (measured as above).

The petroleum resin (C) used for the base layer (i) and surface layer (ii) is a resin directly derived from petroleum-based unsaturated hydrocarbons. Examples include hydrocarbons derived from cyclopentadiene, and alkylstyrene-indene resins derived from higher olefinic hydrocarbons. Preferred examples of the petroleum resin (C) include a polymer (c1) prepared by the cationic polymerization of a polymerizable composition containing a C₅ chain olefin; a polymer (c2) prepared by the thermal polymerization of a polymerizable composition containing dicyclopentadiene; a polymer (c3) prepared by the cationic polymerization of a polymerizable composition containing a C₉ aromatic olefin; a copolymer (c4) prepared by the cationic polymerization of a polymerizable composition containing a C₅ chain olefin and a C₉ aromatic olefin; and a polymer (c5) prepared by hydrogenating the foregoing (c1), (c2), (c3) or (c4), or a modified polymer obtained by introducing a carboxylic acid group, maleic anhydride group and/or hydroxyl group to the foregoing (c1), (c2), (c3) or (c4).

The term “polymerizable composition” used above in regard to the definitions of (c1) to (c4) includes the polymerizable monomer described immediately before such words. The composition may also comprise other polymerizable monomers (i.e., the resulting polymer may be a copolymer), or no other polymerizable monomers (i.e., the resulting polymer may be a homopolymer). If another monomer is present, the amount of this other monomer is preferably 30 wt % or less, more preferably 10 wt % or less, still more preferably 5 wt %, and most preferably 1 wt % or less.

The C₅ chain olefin used for preparing (c1) and (c4) can be, for example, 1-pentene, 2-pentene, 3-pentene, pentadiene, isobutene and isobutadiene. Dicyclopentadiene used for producing (c2) is not specifically limited in regard to the position of the double bonds so long as it is a dimer of cyclopentadiene. The C₉ aromatic olefin used for preparing (c3) and (c4) is a monomer having a total carbon number of 9, and having an aromatic ring and a group bound thereto containing a polymerizable double bond. Examples thereof include o-methylstyrene, m-methylstyrene, p-methylstyrene, 1-phenylpropene, 2-phenylpropene and 3-phenylpropene. These monomers may be used may be used alone (i.e., to prepare a homopolymer), or as mixtures of two or more such monomers. A fraction obtained during petroleum refining is particularly preferred.

Polymers (c1), (c3) and (c4) may be prepared by cationic polymerization. Polymer (c2) may be prepared by thermal polymerization. Polymer (c5) may be prepared by hydrogenation and the introduction of carboxylic acid groups, maleic anhydride groups or hydroxyl groups to (c5) may be carried out under known conditions. An conventional conditions may be used for introducing the above-named groups as long as the target functional group can be successfully introduced.

For the petroleum resin (C), a hydrogenated polymer (c5), having a softening point of 100° C. or above is particularly preferred to provide a film having good color tone and heat resistance.

There is no special limitation on the types of hydrogenated terpene resin (D) which may be used in the stretched resin film of the present invention. In addition, the conditions under which the hydrogenation is carried out, and the ratio of hydrogen addition are also not limited. “CLEARON” (trade name, product of Yasuhara Chemical Co., Ltd.) is a typical example of a suitable terpene resin (D).

Any type of organic and/or inorganic fine powder (E) may be used for the stretched resin film of the present invention. The organic fine powder may comprise, for example, polyethylene terephthalate, polybutylene terephthalate, polyamide, polycarbonate, polyethylene naphthalate, polystyrene, melamine resin, polyethylene sulfide, polyimide, polyethyl ether ketone or polyphenylene sulfide. The preferred organic fine powder (E) has a higher melting point higher than that of the resin composition, in order to effectively form pores.

The inorganic fine powder may be, for example, heavy calcium carbonate, precipitated calcium carbonate, fired clay, talc, titanium oxide, barium sulfate, zinc oxide, magnesium oxide, diatom earth or silicon oxide. Heavy calcium carbonate, fired clay, titanium oxide and diatom earth are particularly preferred since they are inexpensive, opaque and can effectively form pores during the stretching of the film.

The grain size of the organic and/or inorganic fine powder is not specifically limited. The average grain size is preferably within a range from 0.6 to 3 μm. The average grain size of the fine powder used in the surface layer (ii) is preferably smaller than that used in the base layer (i), which reduces surface projections in the film, thereby providing a smoother surface, and allowing high-precision printing. It is also preferable to suppress the content of coarse particle of 44 μm or larger, which causes surface projections, to as low as 10 ppm or less.

The base layer (i) and surface layer (ii) may be selected from the components (A) to (E), and two or more of such components may be preliminarily mixed. The base layer (i) and surface layer (ii) may employ the same material or different materials.

The base layer (i) and surface layer (ii) may contain only one of the petroleum resin (C) and hydrogen-added terpene resin (D), or may contain both the petroleum resin (C) and hydrogen-added terpene resin (D). Preferably, the stretched resin film of the present invention embodiment contains either petroleum resin (C) or hydrogen-added terpene resin (D).

The base layer (i) is prepared by uniaxially stretching a film of the resin composition containing the propylene-based polymer (A) in an amount of 45 to 85 wt %, polybutene-1 (B) in an amount of 5 to 30 wt %, the petroleum resin (C) and/or hydrogen-added terpene resin (D) in an amount of 5 to 30 wt %, and the organic and/or inorganic fine powder (E) in an amount of 5 to 45 wt %. The surface layer (ii) is manufactured by uniaxially stretching a film of the resin composition containing the propylene-base polymer (A) in an amount of 30 to 79 wt %, polybutene-1 (B) in an amount of 3 to 25 wt %, the petroleum resin (C) and/or hydrogen-added terpene resin (D) in an amount of 3 to 25 wt %, organic and/or inorganic fine powder (E) in an amount of 10 to 65 wt %.

The propylene-based polymer (A) used in the base layer (i) provides strength and heat resistance for the stretched resin film, so propylene-based polymer (A) necessarily comprises 45 wt % or more of the base layer (i). If the amount of propylen-based polymer (A) exceeds 85 wt %, however, the low-temperature stretching properties will be poor, and excellent heat shrinking properties will not be obtained.

Polybutene-1 (B) may compatabilize the propylene-base polymer (A), petroleum resin (C) and/or hydrogen-added terpene resin (D), and organic and/or inorganic fine powder (E), facilitate low-temperature stretching, and contribute to improved flexibility, tear resistance and heat-shrinking property of the film. If the content of polybutene-1 (B) is less than 5 wt %, there will be insufficient mixing of the propylene-base polymer (A), petroleum resin (C) and/or hydrogen-added terpene resin (D) and organic and/or inorganic fine powder (E), which inhibits easy stretching. On the contrary, if the amount of polybutene-1 (B) exceeds 30 wt %, the stiffness of the film will be reduced. If such a film is used as an adhesive label, high-speed labeling using an automatic labeler will be difficult.

The petroleum resin (C) and hydrogenated terpene resin (D) can improve the heat-shrinking properties and stiffness of the film of the present invention, and contribute to lowering the apparent melting point of the composition to thereby improve the stretching properties at low temperatures. A total content of the petroleum resin (C) and hydrogenated terpene resin (D) of less than 5 wt % will be unsuccessful in providing excellent heat-shrinking properties and stiffness, and will also reduce the low-temperature stretching properties. A total content of more than 30 wt % will reduce the heat resistance of the film. As a consequence, the tear resistance will be greatly reduced, so that the film will be very likely to break along the stretching direction.

The organic and/or inorganic fine powder (E) is responsible for making the obtained stretched resin film opaque. Amounts of fine powder (E) of less than 5 wt % are not sufficient to provide an opaque film. On the other hand, amounts of fine powder (E) which exceed 45 wt % will provide high opacity, but not uniform stretching, and will therefore cause frequent breakage of the film during stretching.

The propylene-based polymer (A) in the surface layer (ii) improves the surface strength and smoothness of the film. An amount of propylene-based polymer (A) of less than 30 wt % will not provide the desired glossiness and surface strength (hardness) of the film. On the other hand, if the amount of propylene-based polymer (A) exceeds 79 wt %, poor adhesion to printing ink will result. Polybutene-1 (B) functions as a mixing aid for the propylene-base polymer (A), petroleum resin (C) and/or hydrogen-added terpene resin (D), and organic and/or inorganic fine powder (E), as in the base layer (i). It also improves the low-temperature stretching property, flexibility, tear resistance and prevents blocking.

If the amount of polybutene-1 (B) is less than 3 wt %, the stretched resin film will have lowered flexibility and tear resistance, and if the amount of polybutene-1 (B) exceeds 25 wt %, the stretched resin film will have lower surface hardness, and is more likely to become scratched on the surface.

The petroleum resin (C) and hydrogenated terpene resin (D) can improve printability, glossiness and stiffness of the stretched resin film. If the total amount of petroleum resin (C) and hydrogenated terpene resin (D) is less than 3 wt %, the resulting stretched resin film will have poor stiffness, and if the total amount of petroleum resin (C) and hydrogenated terpene resin (D) exceeds 25 wt %, the stretched resin film will have a blocking problem (i.e., the film will tend to stick to itself upon storage).

The organic and/or inorganic fine powder (E) provides opacity, printability (ink adhesion) and prevents blocking. If the amount of the organic and/or inorganic fine powder (E) is less than 10 wt %, the stretched resin film will have poorer ink adhesion, and if the amount of the organic and/or inorganic fine powder (E) exceeds 65 wt %, the stretched resin film will tend to crack or break.

The resin composition forming the base layer (i) and the resin composition forming the surface layer (ii) may comprise, in addition to the foregoing (A) to (E), other additives, such as a heat stabilizer, a UV stabilizer, an antioxidant, an antistatic agent, an anti-blocking agent, a nucleation agent, a lubricant, etc., and mixtures thereof, as required. These additives are preferably added in an amount of 3 wt % or less.

The base layer (i) preferably accounts for 50 to 98% of the total thickness of the stretched resin film. Adjusting the thickness of the base layer (i) within the above range will provide stable stretching properties, and will ensure that the stretched resin film has a suitable stiffness and printability. If the thickness of the base layer (i) is less than 50% of the total thickness of the stretched resin film, the film will tend to have poorer stretching and shrinking properties after low-temperature storage. The total thickness of the stretched resin film of the present invention is preferably within a range from 30 to 250 μm.

The opacity of the stretched resin film of the present invention is preferably 20% or above and more preferably less than 40%. An opacity of less than 20% is insufficient for most uses.

The stretched resin film of the present invention can be manufactured by any known conventional method or combination of methods known to those skilled in the art. The scope of the present invention includes any stretched resin film having the composition and structure described in the present specification, however made.

The individual layers comprising the stretched resin film of the present invention may be formed, for example, by extruding a mixture of the propylene-base polymer (A), polybutene-1 (B), petroleum resin (C) and/or hydrogenated terpene resin (D), mixed in a predetermined ratio, followed by lamination and uniaxial stretching.

The stretched resin film of the present invention having a multi-layered structure may be formed by stacking the base layer (i) and surface layer (ii) after each is separately stretched, or by stretching both layers together after being laminated together. These methods may also be combined.

The preferred method is to stretch the base layer (i) and surface layer (ii) after they have been laminated together. More specifically, an embodiment of the method for preparing stretched resin films of the present invention is preferably to form the surface layer (ii) from a resin composition which comprises the propylene-base polymer (A) in an amount of 30 to 79 wt %, polybutene-1 (B) in an amount of 3 to 25 wt %, petroleum resin (C) and/or hydrogenated terpene resin (D) in an amount of 3 to 25 wt %, and organic and/or inorganic fine powder (E) in an amount of 10 to 65 wt % on at least one side of the base layer (i), which is prepared from a resin composition which comprises propylene-base polymer (A) in an amount of 45 to 85 wt %, polybutene-1 (B) in an amount of 5 to 30 wt %, petroleum resin (C) and/or hydrogenated terpene resin (D) in an amount of 5 to 30 wt %, and organic and/or inorganic fine powder (E) in an amount of 5 to 45 wt %, and then uniaxially stretch the laminate thus formed. This method is simpler and less expensive than methods in which the base layer (i) and surface layer (ii) are laminated together after each is individually stretched.

The stretching can be attained by various known methods. The stretching temperature is preferably set at a temperature which no higher than the melting point of the crystalline resin (i.e., the polypropylene-based polymer and polybutene-1), and no lower than the glass transition temperature of the amorphous resin (i.e., the petroleum resin, hydrogenated terpene resin). More specifically, the stretching is carried out within a range from 65 to 150° C. It is particularly preferred to set the stretching temperature lower by 15° C. or more than the melting point of the propylene-based polymer (A) of the base layer (i).

The stretching method may be, for example, roll stretching in which the stretching is carried out by means of the difference in peripheral speeds of the roll groups, and clip stretching using a tenter oven. In particular, uniaxial roll stretching is preferred in that the stretched film obtained thereby may have a desired shrinkage ratio which is provided by appropriately adjusting the stretching times.

The amount of stretching is not specifically limited, and can properly be determined based on the intended use of the stretched resin film of the present invention, as well as the properties of the resins used therein. The film is generally stretched within a range from 1.5 to 11 times the original dimension of the unstretched film. In particular, 1.5 to 7-fold stretching is preferred for stretched resin films prepared by the roll stretching method, as discussed above, and 5 to 11-fold stretching is preferred for stretched resin films prepared by the clip stretching method, as discussed above. If the stretched resin film comprises a polypropylene homopolymer, polybutene-1 and petroleum resin or hydrogenated terpene resin, the amount of stretching is most preferably selected from within a range from 2 to 7 times the dimension of the unstretched film.

The film is preferably annealed after the stretching. The annealing temperature is preferably selected from within a range between the stretching temperature and a temperature higher which is 30° C. higher than the stretching temperature. The annealing can successfully reduce shrinkage during long-term storage, thereby preventing tightening of the roll of film during long-term storage. The annealing is generally carried out on the rolls or in an oven, or any combination thereof.

As required, corona discharge treatment or plasma treatment of the film surface may be employed in order to improve the adhesion of printing ink to the stretched resin film.

The stretched resin film of the present invention is valuable as a heat-shrinkable film. By virtue of its low heat-shrinking property at low temperatures and high heat-shrinking property at high temperatures, the stretched resin film of the present invention can readily shrink upon heating so that it is applicable to a wide variety of products. For example, the amount and type of materials comprising the stretched resin film of the present invention is controlled so as to provide a heat shrinkage ratio in the stretching direction of 1% or less at 50° C., and 25% or above at 100° C. In particular, a heat shrinkage ratio at 100° C. of 25% provides heat shrinking properties suitable for use as a shrinkable label having an attractive appearance. A heat shrinkage ratio at 50° C. of % or less is preferred to prevent tightening of the roll of film during storage, thereby ensuring good printability.

The stretched resin film of the present invention has a large Clark stiffness in the stretching direction. Stretched resin films having a Clark stiffness within a range of from 10 to 300 are preferred. If the Clark stiffness of the stretched resin film is less than 10, a label comprising this film tends to cause dropping or misalignment of the label during labeling using an automatic labeler, due to poor stiffness of the label itself, after it is removed from the released paper. If the Clark stiffness of the stretched resin film exceeds 300, placement of a label comprising this film onto round containers or the like tends to be difficult due to the excessive self-supporting property of the label.

The stretched resin film of the present invention may be used, itself, or as a laminate with another resin film. The stretched resin film of the present invention may also be laminated on a transparent film such as polyester film, polyamide film, polyolefin film and the like.

The stretched resin film of the present invention may be used in various applications, and is valuable as container labels for various beverage cans and various beverage bottles, labels for dry cells, and wrapping materials for various containers.

The surface layer (ii) and opposite layer of the stretched resin film of the present invention may be printed, as desired, depending on the application. There is no special limitation on the types and methods of printing the stretched resin film of the present invention. Examples of suitable printing methods include known printing techniques such as gravure printing, flexography, silk screen printing, offset printing, seal printing, UV offset press printing using ink which contains a pigment dispersed in a known vehicle. Metal vapor deposition, gross printing, matt printing, and fusion thermal transfer printing are also available. The back surface of the film is preferably subjected to metal vapor deposition.

The stretched resin film of the present invention may also be provided as a heat-shrinkable, pressure-sensitive adhesive label, if it is treated on one surface with known methods of forming a pressure sensitive and tacky layer. The stretched resin film of the present invention can also be provided on one surface with heat-sensitive color developing coating to thereby provide a heat-shrinkable color label. Such specifically functionalized stretched resin films according to the present invention may be used as labels for various containers and wrapping materials. In particular, by virtue of their shrinking properties, such films are valuable as labels for dry cells.

The present invention will further be described with reference to specific Examples and Comparative Examples. It is to be noted that the materials, amounts and ratios of materials used, details of methods and procedures can properly be modified without departing from the spirit of the present invention. Therefore the scope of the present invention should not be limited by the specific Examples described below.

Materials employed herein are listed in Table 1. The notation “MFR” in Table 1 is an abbreviation of “melt flow rate”.

TABLE 1

| Material | | Description |
|---|---|---|
| (1) | Propylene homopolymer (a4) | MFR = 4 g/10 min (230° C., 2.16 kg load), m.p. 164° C. (DSC |
| | | peak temperature) (product of Mitsubishi Chemical |
| | | Corporation) |
| (2) | Ethylene/propylene | MFR = 5 g/10 min (230° C., 2.16 kg load), m.p. 137° C. (DSC |
| | random copolymer (a1) | peak temperature) (product of Mitsubishi Chemical |
| | | Corporation) |
| (3) | Ethylene/propylene/ | MFR = 3 g/10 min (230° C., 2.16 kg load), m.p. 132° C. (DSC |
| | butene-1 random | peak temperature) (product of Mitsubishi Chemical |
| | copolymer (a3) | Corporation) |
| (4) | Polybutene-1 | MFR = 4 g/10 min (230° C., 2.16 kg load), m.p. 97° C. (DSC |
| | | peak temperature) (product of Mitsui Chemicals Inc.) |
| (5) | Hydrogenated | softening temperature = 125° C., |
| | petroleum resin | hydrogenated C₉-base petroleum resin |
| | | (product of Arakawa Chemical Industries, Ltd.) |
| (6) | Hydrogenated | softening temperature = 125° C., |
| | petroleum resin (c3) | hydrogenated dicyclopentadiene-base |
| | | petroleum resin (product of Tonex Co., Ltd.) |
| (7) | Hydrogenated terpene | softening temperature = 125° C., |
| | resin | (product of Yasuhara Chemical Co., Ltd.) |
| (8) | Low-density | m.p. 106° C., density = 0.918 (product of Mitsubishi |
| | polyethylene | Chemical Corporation) |
| (9) | Heavy calcium | average grain size = 1.2 μm, dry ground |
| | carbonate | (product of Shiraishi Calcium Co., Ltd.) |

### EXAMPLES 1 to 11, and Comparative Examples 1 to 7

The stretched resin films of the present invention (Example 1 to 11), and comparative stretched resin films (Comparative Examples 1 to 7) were prepared and further treated to provide heat-shrinking labels according to the procedures below.

The propylene-based polymer (A), polybutene-1 (B), and petroleum resin (C) or hydrogenated terpene resin (D), and organic or inorganic fine power (E) were mixed according to the material selection and amount of blending shown in Tables 2 and 3. In Examples 1 to 3 and Comparative Example 1, the compound was kneaded under fusion conditions in an extruder set at 230° C., extrusion-molded, and cooled to 50° C. using a cooling apparatus, thereby providing an unstretched sheet. In Examples 4 to 11 and Comparative Examples 2 to 7, two compounds, (i) and (ii), were separately kneaded under fusion conditions in two extruders set at 230° C. Compound (ii) was disposed on the upper side of the compound (i) within an extrusion die, and the two compounds were coextruded in the form of a film, and then cooled to 50° C. using a cooling apparatus, thereby providing a two-layered, unstretched sheet.

Each sheet of Examples 1-5 and 7-11 and Comparative Examples 1-6 was heated and then stretched longitudinally between rolls according to the stretching temperatures and stretching times listed in Tables 2 and 3. Each sheet of Example 6 and Comparative Example 7 was heated and then stretched transversely by being pinched with clips in a heat oven according to the stretching temperatures and stretching times listed in Tables 2 and 3. Each of the stretched films was then annealed at a temperature listed in Tables 2 and 3, and then cooled to provide a stretched film. The resulting stretched film was then treated on both surfaces by corona discharge treatment at 40 W/m² using a corona discharge treatment apparatus (product of Kasuga Denki K.K.), to provide a stretched resin film having a total thickness as listed in Tables 2 and 3.

The surface layer (ii) of the thus obtained stretched resin film was then printed with a pattern by gravure printing, using an ink (product name CCST, product of Toyo Ink Mfg. Co., Ltd.), and the back surface of the film was then laminated with a release paper, having coated thereon a pressure-sensitive adhesive in an amount of 10 g/m², to provide an adhesive sheet with a release paper covering the adhesive layer. Only the label portion of the resulting laminate was then punched (leaving the release paper unpunched) to provide an adhesive-coated and punched label having a roll shape.

The stretched resin film was then assessed for opacity, shrinkage ratio, and Clark stiffness. The label was assessed for the ink adhesion on the surface layer (ii), suitability for automatic labeling and heat-shrinking properties. Details of the individual tests are shown below.

(1) Opacity

Opacity was measured using a measurement instrument “SM COLOR COMPUTER” (trade name, product of Suga Test Instruments Co., Ltd.) according to the method of JIS Z-8722.

2) Shrinkage Ratio

A 10 cm×10 cm sample of the stretched resin film was successively dipped in a water bath set at 50° C. and a silicone oil bath set at 90° C. for 10 seconds, respectively, immediately taken out, and then cooled by dipping in a cold water bath at 20° C. The length of the film in the longitudinal direction (post-dipping length) was measured, and size shrinkage ratio (simply referred to as “shrinkage ratio”, hereinafter) in the stretching direction was determined based on the equation below.

$$Shrinkage ratio ( \% ) = \frac{\begin{matrix}pre \text{-} dipping \\ length\end{matrix} - \begin{matrix}post \text{-} dipping \\ length\end{matrix}}{\begin{matrix}pre \text{-} dipping \\ length\end{matrix}} \times 100$$

3) Clark Stiffness

The Clark stiffness was measured using an “AUTOMATIC CLARK STIFFNESS TESTER” (trade name, product of Kumagaya Riki Kogyo K.K.) according to the method of JIS P-8143.

4) Ink Adhesion of Surface Layer (ii)

An adhesive tape (product name “CELLOTAPE”, product of Nichiban Co., Ltd.) was stuck on the gravure-printed surface, thoroughly pressed, and then peeled off at a constant velocity and at a constant angle of 90° away from the adhesive plane. The amount of ink removal was visually checked and assessed according to the criteria below:

◯: no ink removal was observed;

A : commercially undesirable; most of the ink was removed but peeling resistance was good; and

x: commercially unusable: all of the ink was removed and peeling resistance was poor.

5) Suitability for Automatic Labeling

One hundred adhesive-coated and punched labels having a roll shape were placed around dry cells (AM-1 type) using an automatic labeler “MD-1” (trade name, product of Lintec Corporation) at a speed of 300 labels/min so as to align the stretching direction thereof to the circumference of the cell body. The placement of the labels was assessed according to the criteria below.

◯: each of 100 labels was attached in place;

Δ: 1 to 9 labels out of 100 labels was improperly placed; and

x: 10 or more labels out of 100 labels were improperly placed.

The labels of Example 6 and Comparative Example 7 were not assessed since the automatic labeler was not applicable to such transversely-stretched films. Instead, these labels were manually labeled on the circumference of the cell body, and the resultant labeled cells were used in the next test.

6) Heat-shrinking Property

Fifty dry cells, labeled using an automatic labeler or manually labeled, were passed through an heated air furnace at a temperature of 250° C. at speed of 25 m/min. The outer appearance of the dry cells and the heat-shrunken labels were assessed according to the criteria below.

\mathring{0}: the labels uniformly shrunk at the top and bottom portions of the dry cells;

◯: commercially usable, although a slight non-uniformity was found in the shrinkage of the label at the top and bottom portions of the dry cells;

Δ: commercially undesirable because the non-uniformity in the shrinkage of the labels at the top and bottom portions of the dry cell ruined the appearance of the label; and

x: commercially unusable because the labels “floated” at the top and bottom portions of the dry cells due to poor shrinkage properties.

The test results are shown in Tables 2 to 4. Breakage of the film during the stretching frequently occurred in Comparative Examples 1 and 6, and film looseness was observed in Comparative Example 7.

TABLE 2

| | Base | Surface | | | | | | |
|---|---|---|---|---|---|---|---|---|
| | layer | layer | Stretching | Anneal- | Layer | | Shrink- | Clark |
| | (i) | (ii) | conditions | ing | thick- | Opac- | age | stiff- |
| | Material | Material | Temp. (° C.), | temp. | ness | ity | ratio | ness |
| | wt % | wt % | times | (° C.) | (i)/(ii) | (%) | 50/100° C. | MD/CD |
| Example 1 | (1) 50 | | 85 4 | 95 | 60 | 55 | 0.4/38 | 16/12 |
| | (4) 20 | | | | | | | |
| | (5) 20 | | | | | | | |
| | (9) 10 | | | | | | | |
| Example 2 | (2) 40 | | 85 4 | 90 | 85 | 93 | 0.7/38 | 20/13 |
| | (4) 10 | | | | | | | |
| | (6) 10 | | | | | | | |
| | (9) 40 | | | | | | | |
| Example 3 | (1) 30 | | 85 4 | 110 | 60 | 97 | 0.2/30 | 13/10 |
| | (4) 5 | | | | | | | |
| | (5) 5 | | | | | | | |
| | (9) 60 | | | | | | | |
| Comparative | (1) 31 | | 110 4 | 80 | 60 | 98 | 3.8/15 | 7/4 |
| Example 1 | (4) 1 | | | | | | | |
| | (5) 1 | | | | | | | |
| | (9) 67 | | | | | | | |
| Example 4 | (1) 62 | (1) 60 | 85 5 | 90 | 80/5 | 45 | 0.7/35 | 26/14 |
| | (4) 15 | (4) 10 | | | | | | |
| | (5) 15 | (5) 10 | | | | | | |
| | (9) 8 | (9) 20 | | | | | | |
| Example 5 | (1) 62 | (1) 60 | 70 3 | 80 | 80/5 | 60 | 0.8/42 | 29/17 |
| | (4) 15 | (4) 10 | | | | | | |
| | (6) 15 | (5) 10 | | | | | | |
| | (9) 8 | (9) 20 | | | | | | |
| Example 6 | (1) 62 | (1) 60 | 145 9 | 150 | 80/5 | 50 | 0.7/33 | 12/33 |
| | (4) 15 | (4) 10 | | | | | | |
| | (6) 15 | (5) 10 | | | | | | |
| | (9) 8 | (9) 20 | | | | | | |
| Example 7 | (2) 46 | (1) 32 | 85 4 | 90 | 45/40 | 97 | 0.9/37 | 24/13 |
| | (4) 7 | (4) 4 | | | | | | |
| | (6) 7 | (6) 4 | | | | | | |
| | (9) 40 | (9) 60 | | | | | | |
| Example 8 | (3) 45 | (1) 33 | 85 4 | 90 | 58/2 | 70 | 0.8/40 | 15/12 |
| | (4) 25 | (4) 20 | | | | | | |
| | (7) 15 | (7) 10 | | | | | | |
| | (9) 15 | (9) 37 | | | | | | |
| Example 9 | (1) 59 | (1) 43 | 85 4 | 95 | 55/5 | 88 | 0.7/35 | 13/11 |
| | (4) 8 | (4) 6 | | | | | | |
| | (5) 8 | (5) 6 | | | | | | |
| | (9) 25 | (9) 45 | | | | | | |
| Example 10 | (2) 50 | (2) 34 | 90 4 | 100 | 150/25 | 98 | 0.9/43 | 110/58 |
| | (4) 5 | (4) 4 | | | | | | |
| | (5) 30 | (5) 25 | | | | | | |
| | (9) 15 | (9) 37 | | | | | | |

TABLE 3

| | | | | | | | | |
|---|---|---|---|---|---|---|---|---|
| Example 11 | (2) 50 | (2) 34 | 85 4 | 90 | 55/5 | 78 | 0.9/42 | 10/8 |
| | (4) 5 | (4) 25 | | | | | | |
| | (5) 30 | (5) 4 | | | | | | |
| | (9) 15 | (9) 37 | | | | | | |
| Comparative | (1) 22 | (1) 23 | 85 4 | 90 | 55/5 | 18 | 2.9/51 | 6/5 |
| Example 2 | (4) 37 | (4) 33 | | | | | | |
| | (5) 38 | (5) 32 | | | | | | |
| | (9) 3 | (9) 12 | | | | | | |
| Comparative | (2) 47 | (2) 31 | 85 4 | 90 | 55/5 | 96 | 0.5/15 | 8/6 |
| Example 3 | (4) 3 | (4) 1 | | | | | | |
| | (8) 3 | (5) 1 | | | | | | |
| | (9) 47 | (9) 67 | | | | | | |
| Comparative | (2) 44 | (2) 27 | 85 4 | 80 | 55/5 | 70 | 1.9/38 | 12/10 |
| Example 4 | (4) 4 | (4) 5 | | | | | | |
| | (5) 37 | (5) 31 | | | | | | |
| | (9) 15 | (9) 37 | | | | | | |
| Comparative | (2) 44 | (2) 27 | | | | | | |
| Example 5 | (4) 37 | (4) 34 | 85 4 | 90 | 55/5 | 76 | 0.9/23 | 5/3 |
| | (5) 4 | (5) 2 | | | | | | |
| | (9) 15 | (9) 37 | | | | | | |
| Comparative | (1) 62 | (1) 60 | 60 6 | 100 | 80/5 | 85 | 3.5/18 | 35/19 |
| Example 6 | (4) 15 | (4) 10 | | | | | | |
| | (5) 15 | (5) 10 | | | | | | |
| | (9) 8 | (9) 20 | | | | | | |
| Comparative | (1) 62 | (1) 60 | 155 12 | 170 | 80/5 | 15 | 0.2/6 | 7/21 |
| Example 7 | (4) 15 | (4) 10 | | | | | | |
| | (5) 15 | (5) 10 | | | | | | |
| | (9) 8 | (9) 20 | | | | | | |

TABLE 4

| | Ink adhesion | Labeling | Heat-shrinking |
|---|---|---|---|
| | property | suitability | Property |
| Example 1 | ◯ | ◯ | ⊚ |
| Example 2 | ◯ | ◯ | ⊚ |
| Example 3 | ◯ | ◯ | ◯ |
| Comparative example 1 | ◯ | Δ | X |
| Example 4 | ◯ | ◯ | ⊚ |
| Example 5 | ◯ | ◯ | ⊚ |
| Example 6 | ◯ | not assessed | ◯ |
| Example 7 | ◯ | ◯ | ⊚ |
| Example 8 | ◯ | ◯ | ⊚ |
| Example 9 | ◯ | ◯ | ⊚ |
| Example 10 | ◯ | ◯ | ⊚ |
| Example 11 | ◯ | ◯ | ⊚ |
| Comparative Example 2 | Δ | Δ | ⊚ |
| Comparative Example 3 | ◯ | Δ | X |
| Comparative Example 4 | Δ | ◯ | ⊚ |
| Comparative Example 5 | ◯ | X | Δ |
| Comparative Example 6 | ◯ | ◯ | X |
| Comparative Example 7 | ◯ | not assessed | X |

As is clear from the above results, the stretched resin film of the present invention has excellent stiffness in the stretching direction and white opacity, and exhibits only a small amount of shrinkage during storage but a large amount of shrinkage upon heating. A label manufactured using the stretched resin film of the present invention has excellent opacity, ink adhesion, is suitable for use in labeling equipment, and good heat-shrinking properties, and is therefore suitable for commercial use as a label (i.e., Examples 1 to 11). On the contrary, stretched resin films departing from the conditions specified by the present invention have poor properties, and are therefore not suitable for commercial applications (i.e., Comparative Examples 1 to 7).

### Commercial Applicability

The stretched resin film of the present invention is a white, opaque, heat-shrinkable film having a large amount of stiffness in the stretching direction, and exhibiting only a small amount of shrinkage during storage but a large amount of shrinkage upon heating. The stretched resin film of the present invention can provide commercially useful white, opaque labels or wrapping materials having excellent ink adhesion, suitability for use as labels, and good heat-shrinking properties. The manufacturing method of the present invention can produce such stretched resin film in an inexpensive and simple manner. The stretched resin film of the present invention is suitable for a wide variety of applications including labels or wrapping materials for dry cells, can containers or bottle containers.

The priority document of the present application, Japanese application 11/332361, filed Nov. 24, 1999, is incorporated herein by reference.

What is claimed is:

1. A stretched resin film comprising a uniaxially stretched film comprising 30 to 79 wt % of a propylene-based polymer (A), 3 to 25 wt % of a polybutene-1 (B), 3 to 25 wt % of a petroleum resin (C) and/or hydrogenated terpene resin (D), and 10 to 65 wt % of an organic and/or inorganic fine powder (E).

2. A stretched resin film comprising:
a base layer (i) comprising a uniaxially stretched film; and
a surface layer (ii) according to claim 1 disposed on at least one surface of the base layer (i);
wherein the base layer (i) comprises 45 to 85 wt % of a propylene-based polymer (A), 5 to 30 wt % of a polybutene-1 (B), 5 to 30 wt % of a petroleum resin (C) and/or hydrogenated terpene resin (D), and 5 to 45 wt % of an organic and/or inorganic fine powder (E).

3. The stretched resin film of claim 1, wherein the propylene-based polymer (A) is selected from the group consisting of:
(a1) a random copolymer comprising 2 to 10 wt % of ethylene and 90 to 98 wt % of propylene;
(a2) a random copolymer comprising 0 to 5 wt % of ethylene, 8 to 30 wt % of butene-1, and 92 to 65 wt % of propylene;
(a3) a random copolymer comprising 0 to 5 wt % of ethylene, 65 to 98.5 wt % of propylene, and 0 to 30 wt % of butene-1; and
(a4) a propylene homopolymer.

4. The stretched resin film of claim 2, wherein the propylene-based polymer (A) is selected from the group consisting of:
(a1) a random copolymer comprising 2 to 10 wt % of ethylene and 90 to 98 wt % of propylene;
(a2) a random copolymer comprising 0 to 5 wt % of ethylene, 8 to 30 wt % of butene-1, and 92 to 65 wt % of propylene;
(a3) a random copolymer comprising 0 to 5 wt % of ethylene, 65 to 98.5 wt % of propylene, and 0 to 30 wt % of butene-1; and
(a4) a propylene homopolymer.

5. The stretched resin film of claim 1, wherein the petroleum resin (C) is selected from the group consisting of:
(c1) a polymer prepared by the cationic polymerization of a polymerizable composition comprising a C₅ chain olefin;
(c2) a polymer prepared by the thermal polymerization of a polymerizable composition comprising dicyclopentadiene;
(c3) a polymer prepared by the cationic polymerization of a polymerizable composition comprising a C₉ aromatic olefin;
(c4) a copolymer prepared by the cationic polymerization of a polymerizable composition comprising a C₅ chain olefin and a C₉ aromatic olefin;
(c5) a polymer prepared by the hydrogenation of any of (c1), (c2), (c3) or (c4); and modified polymer prepared by introducing a carboxylic acid group, maleic anhydride group and/or hydroxyl group to any of (c1), (c2), (c3) or (c4).

6. The stretched resin film of claim 2, wherein the petroleum resin (C) is selected from the group consisting of:
(c1) a polymer prepared by the cationic polymerization of a polymerizable composition comprising a C₅ chain olefin;
(c2) a polymer prepared by the thermal polymerization of a polymerizable composition comprising dicyclopentadiene;
(c3) a polymer prepared by the cationic polymerization of a polymerizable composition comprising a C₉ aromatic olefin;
(c4) a copolymer prepared by the cationic polymerization of a polymerizable composition comprising a C₅ chain olefin and a C₉ aromatic olefin;
(c5) a polymer prepared by the hydrogenation of any of (c1), (c2), (c3) or (c4); and
a modified polymer prepared by introducing a carboxylic acid group, maleic anhydride group and/or hydroxyl group to any of (c1), (c2), (c3) or (c4).

7. The stretched resin film of claim 1, wherein the stretched resin film has a heat-shrinkage ratio in the stretching direction of 25% or above at 100° C., and 1% or less at 50° C.

8. The stretched resin film of claim 2, wherein the stretched resin film has a heat-shrinkage ratio in the stretching direction of 25% or above at 100° C., and 1% or less at 50° C.

9. The stretched resin film of claim 1, wherein the stretched resin film has a Clark stiffness in the stretching direction within a range from 10 to 300.

10. The stretched resin film of claim 2, wherein the stretched resin film has a Clark stiffness in the stretching direction within a range from 10 to 300.

11. The stretched resin film of claim 2, wherein the stretched resin film has a total thickness of 30 to 250 μm, and the base layer (i) has a thickness within a range from 50 to 98% of the total thickness of the stretched resin film.

12. The stretched resin film of claim 1, wherein the stretched resin film has an opacity of 20% or above.

13. The stretched resin film of claim 2, wherein the stretched resin film has an opacity of 20% or above.

14. The stretched resin film of claim 1, wherein the stretched resin film further comprises a pressure-sensitive adhesive.

15. The stretched resin film of claim 2, wherein the stretched resin film further comprises a pressure-sensitive adhesive.

16. The stretched resin film of claim 1, wherein the propylene-based polymer (A) comprises more than 50 wt % of propylene.

17. The stretched resin film of claim 1, wherein the propylene-based polymer (A) comprises more than 60 wt % of propylene.

18. The stretched resin film of claim 1, wherein the propylene-based polymer (A) comprises more than 65 wt % of propylene.

19. The stretched resin film of claim 1, wherein the polybutene-1 (B) has a melt flow rate of 1 g/10 min or above.

20. The stretched resin film of claim 1, wherein the powder (E) is an organic powder selected from the group consisting of polyethylene terephthalate, polybutylene terephthalate, polyamide, polycarbonate, polyethylene naphthalate, polystyrene, melamine resin, polyethylene sulfide, polyimide, polyethyl ether ketone, polyphenylene sulfide, and mixtures thereof.

21. The stretched resin film of claim 1, wherein the powder (E) is an inorganic powder selected from the group consisting of heavy calcium carbonate, precipitated calcium carbonate, fired clay, talc, titanium oxide, barium sulfate, zinc oxide, magnesium oxide, diatom earth, silicon oxide, and mixtures thereof.

22. The stretched resin film of claim 1, wherein the powder (E) has an average grain size of 0.6 to 3 μm.

23. A method of preparing the stretched resin film of claim 1, comprising:
preparing a resin composition comprising 30 to 79 wt % of a propylene-based polymer (A), 3 to 25 wt % of polybutene-1 (B), 3 to 25 wt % of a petroleum resin (C) and/or hydrogenated terpene resin (D), and 10 to 65 wt % of an organic and/or inorganic fine powder (E);
preparing an unstretched resin film of the resin composition; and
uniaxially stretching the unstretched resin film, thereby providing a stretched resin film.

24. A method of preparing the stretched resin film of claim 2, comprising:
preparing a resin composition (i) comprising 45 to 85 wt % of a propylene-based polymer (A), S to 30 wt % of polybutene-1 (B), 5 to 30 wt % of a petroleum resin (C) and/or hydrogenated terpene resin (D), and 5 to 45 wt % of an organic and/or inorganic fine powder (E);
preparing a resin composition (ii) comprising 30 to 79 wt % of a propylene-based polymer (A), 3 to 25 wt % of polybutene-1 (B), 3 to 25 wt % of a petroleum resin (C) and/or hydrogenated terpene resin (D), and 10 to 65 wt % of an organic and/or inorganic fine powder (E);
forming an unstretched film comprising a base layer (i) and a surface layer (ii), wherein the surface layer (ii) is disposed on at least one surface of the base layer (i); and
uniaxially stretching the unstretched film at a stretching temperature to provide a stretched resin film.

25. The method of claim 23, wherein the stretching temperature is 65 to 150° C., and the film is stretched 1.5 to 11-fold.

26. The method of claim 24, wherein the stretching temperature is 65 to 150° C., and the film is stretched 1.5 to 11-fold.

27. The method of claim 23, further comprising annealing the stretched film at a temperature range extending from the stretching temperature to a temperature 30° C. higher than the stretching temperature.

28. The method of claim 24, further comprising annealing the stretched film at a temperature range extending from the stretching temperature to a temperature 30° C. higher than the stretching temperature.

29. The method of claim 23, wherein said uniaxial stretching comprises a method selected from the group consisting of stretching with the peripheral speeds of roller groups and stretching by pinching the unstretched resin film with a clip in a heat oven and uniaxially extending the film.

30. The method of claim 24, wherein said uniaxial stretching comprises a method selected from the group consisting of stretching with the peripheral speeds of roller groups and stretching by pinching the unstretched resin film with a clip in a heat oven and uniaxially extending the film.

31. The method of claim 24, wherein said forming is coextruding.

32. A heat-shrunk resin film prepared by heating the stretched resin film of claim 1 to temperature sufficient to shrink the stretched resin film.

33. A heat-shrunk resin film prepared by heating the stretched resin film of claim 2 to temperature sufficient to shrink the stretched resin film.

34. The stretched resin film of claim 1, having printing on at least one surface of the stretched resin film.

35. The stretched resin film of claim 2, having printing on at least one surface of the stretched resin film.

36. The heat-shrunk resin film of claim 32, having printing on at least one surface of the heat-shrunk resin film.

37. The heat-shrunk resin film of claim 33, having printing on at least one surface of the heat-shrunk resin film.

38. A label comprising the heat-shrunk resin film of claim 32.

39. A label comprising the heat-shrunk resin film of claim 33.

40. A label comprising the stretched resin film of claim 1.

41. A label comprising the stretched resin film of claim 2.

42. An article having the heat-shrunk film of claim 32 disposed on at least a portion of the surface of the article.

43. An article having the heat-shrunk film of claim 33 disposed on at least a portion of the surface of the article.

44. The article of claim 42, wherein the article is selected from the group consisting of a dry cell, a container, and a bottle.

45. The article of claim 43, wherein the article is selected from the group consisting of a dry cell, a container, and a bottle.
